(19) United States
(12) Patent Application Publication
(10) Pub. No.: US 2010/0142619 A1
(43) Pub. Date: Jun. 10, 2010

(54) APPARATUS AND METHOD FOR PROCESSING IMAGE

(75) Inventors: Shingo Suzuki, Akishima-shi (JP); Hirofumi Mori, Koganei-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/488,776

(22) Filed: Jun. 22, 2009

(30) Foreign Application Priority Data
Dec. 8, 2008 (JP) 2008-312573

(51) Int. Cl. H04N 7/26; H04N 7/36

(52) U.S. Cl. 375/240.16; 375/240.26; 375/240.25; 375/E07.027; 348/E07.003; 375/E07.263

(57) ABSTRACT

An asynchronous IDR detecting unit detects occurrence of scene change and, upon noticing that at the scene change superiority and inferiority of image quality can hardly be recognized by a human eye and a high-image-quality interpolation frame cannot be generated, a frame interpolation process controlling unit controls a frame interpolation unit to generate an interpolation frame by a simplified process before and after a case where a frame including the scene change (aperiodic IDP frame) is detected (necessity of frame interpolation is small) or generate a high-image-quality interpolation frame in the other case (a case where necessity of the frame interpolation is great).

### CROSS-REFERENCE TO RELATED APPLICATIONS

This application is based upon and claims the benefit of priority from prior Japanese Patent Application No. 2008-312573, filed Dec. 8, 2008, the entire contents of which are incorporated herein by reference.

### BACKGROUND OF THE INVENTION

1. Field of the Invention

The present invention relates to an image processing apparatus capable of improving moving image quality.

2. Description of the Related Art

A frame interpolation technique of increasing the number of display frames per unit time is known. The frame interpolation technique increases the number of display frames per unit time by predicting from moving image frames serving as input signals a frame which is to be present between the moving image frames and inserting the predicted frame into the moving image frames. This technique has benefits that a sequence between the frames is smoothed, a feeling of blur of the display is not made, and the like by the frame interpolation.

In addition, a technique of performing scene change detection with inter-frame difference and encoding information (motion vector, picture type and encoding type) and skipping the frame interpolation at the scene change has been proposed (for example, Jpn. Pat. Appln. KOKAI Publication No. 2004-112229). According to this technique, a detection error of the scene change is often caused since the scene change is detected on the basis of the frequency information of intra-macro block. In a case of employing a recursive frame interpolation technique, however, if the scene change is erroneously detected and the frame interpolation is skipped, motion information which is to be assigned to a previously interpolated frame is not generated and quality of a subsequently interpolated frame is degraded.

In addition, the frame interpolation technique requires a number of signal processes. In a portable electronic device such as a cellular telephone, the frame interpolation bears much load on a processor since the processing performance of the processor is limited. Since the portable electronic device is driven with a battery, available power is limited, and a problem arises that the power consumption is increased and the operation time is shortened when the frame interpolation is performed.

In the image processing apparatus performing the conventional frame interpolation, the scene change is erroneously detected and the image quality is degraded. In addition, load on the processor is not small and the power consumption is large for the frame interpolation.

### BRIEF SUMMARY OF THE INVENTION

The present invention has been accomplished to solve the above-described problems. The object of the present invention is to provide an image processing apparatus an image processing method, capable of reducing load on the processor and performing frame interpolation which can be sufficiently recognized as high image quality by human perception abilities, with lower power consumption.

To achieve the object, the present invention is an image processing apparatus comprising:

a receiving unit which receives data including a plurality of encoded moving image frames and encoding information referred to upon decoding each of the encoded moving image frames;

a decoder which decodes the data received by the receiving unit and extracts the plurality of moving image frames and the encoding information;

an interpolation frame generating unit which generates an interpolation frame to be inserted into the plurality of timely sequential moving image frames extracted by the decoder; and

a detector which detects a specific moving image frame in accordance with the encoding information extracted by the decoder,

wherein if the detector detects the specific moving image frame, the interpolation frame generating unit generates the interpolation frame inserted between the detected specific moving image frame and a moving image frame followed by the specific moving image frame by duplicating the detected specific moving image frame or the moving image frame followed by the specific moving image frame, and if the detector does not detect the specific moving image frame, the interpolation frame generating unit generates the interpolation frame inserted between a moving image frame which is not detected as the specific moving image frame and a moving image frame followed by the moving image frame in accordance with a motion vector obtained each of blocks constituting the interpolation frame.

In the present invention, as described above, necessity of the frame interpolation is discriminated on the basis of the encoding information which can be obtained by decoding the encoded data, and the interpolated frame of a prediction accuracy according to the discrimination result is generated.

According to the present invention, an interpolated frame which is small in processing load and low in prediction accuracy can be generated when the necessity of the frame interpolation is small while an interpolated frame which is large in processing load and high in prediction accuracy can be generated when the necessity of the frame interpolation is great. The present invention can therefore provide an image processing apparatus and image processing method, capable of reducing load on the processor and performing frame interpolation which can be sufficiently recognized as high image quality by human perception abilities, with lower power consumption.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a mobile radio terminal equipped with an image processing apparatus according to an embodiment of the present invention;

FIG. 2 is a block diagram showing a configuration concerning frame interpolation in the image processing apparatus shown in FIG. 1;

FIG. 3 is a diagram showing an operation of a frame interpolation unit shown in FIG. 2;

FIG. 4 is a diagram showing an operation of a frame interpolation unit shown in FIG. 2; and

FIG. 5 is a diagram showing an operation of a frame interpolation unit shown in FIG. 2.

### DETAILED DESCRIPTION OF THE INVENTION

Embodiments of the present invention will be explained below with reference to the accompanying drawings.

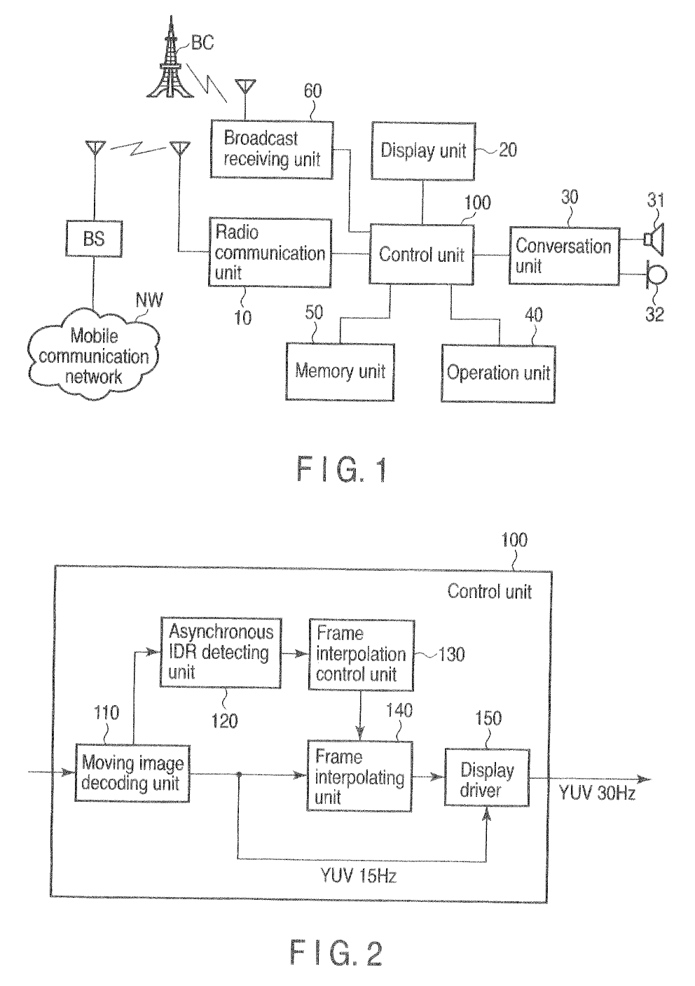

FIG. 1 is a block diagram showing a configuration of a mobile radio terminal equipped with an image processing apparatus according to an embodiment of the present invention. The mobile radio terminal comprises as its main constituent elements, a control unit 100, a radio communication unit 10, a display unit 20, a conversation unit 30, an operation unit 40, a memory unit 50 and a broadcast receiving unit 60. The mobile radio terminal also comprises a communication function for performing communications via a base station apparatus BS and a mobile communication network NW to perform speech conversation and data communication (transmission and reception of electronic mails and Web browsing), a broadcast reception function for receiving a ground digital broadcast signal transmitted from the broadcast station BC, and a reproduction function for output ting images and speech based on content data stored in the memory unit 50 and the broadcast signal, as shown in FIG. 1.

The radio communication unit 10 performs radio communications with the base station with the base station apparatus BS accommodated in the mobile communication network NW under instructions of the control unit 100, and performs the transmission and reception of speech data, electronic mail data and the like and the reception of Web data, streaming data and the like by the radio communications.

The display unit 20 is display means utilizing, for example, LCD (Liquid Crystal Display) or organic EL (Electro Luminescence) display. The display unit 20 visually transmits the information to the user by displaying images (still images and moving images), character information and the like under control of the control unit 100.

The conversation unit 30 comprises a speaker 31 and a microphone 32, and converts user's speech input via the microphone 32 into speech data and outputs the speech data to the control unit 100, and decodes speech data received from a conversation partner or the like and outputs the decoded data from the speaker 31.

The operation unit 40 comprises a plurality of key switches and the like, and accepts instructions from the user via the key switches and the like.

The memory unit 50 stores control programs and control data of the control unit 100, application software, address data managed in association with names, telephone numbers and the like of communication partners, transmitted and received electronic mail data, Web data downloaded by Web browsing, and downloaded content data, and temporarily stores streaming data and the like. The memory unit 50 can be constituted by one of HDD, RAM, ROM, flash memory and the like or combining some of them.

The broadcast receiving unit 60 is a tuner configured to receive ground digital broadcast signals transmitted from a broadcast station BC. The broadcast receiving unit 60 receives, for example, one-segment broadcast, for mobiles, of the ground digital broadcast signals. Signals included in the one-segment broadcast are the encoded moving image data obtained by encoding moving image data in a format such as H.264 and the like, encoded speech/audio data obtained by encoding speech/audio data in a format such as AAC and the like, and broadcast content data obtained by multiplexing text data.

The control unit 100 comprises a microprocessor, makes operations under control programs and control data stored in the memory unit 50 and entirely controls each of the units of the mobile radio terminal to implement speech communications and data communications. In addition, the control unit 100 makes operations according to application software scored in the memory unit 50, and has a data communication control function for performing the transmission and reception of electronic mails, Web browsing, a speech communication control function for performing speech communications, and a reproduction control function for displaying a moving image on the display unit 20 on the basis of the content data, the streaming data and the broadcast content.

The control unit 100 comprises a moving image decoding unit 110, an aperiodic IDR detecting unit 120, a frame interpolation control unit 130, a frame interpolating unit 140, and a display driver 150 as shown in FIG. 2, as constituent elements to implement the reproduction control function. They process the moving image data. Besides them, the control unit 100 comprises an audio decoding unit configured to decode the encoded speech/audio data though it is not shown in the drawings.

The moving image decoding unit 110 is configured to decode encoded moving image data (Video Elementary Stream) and thereby obtain moving image data constituted by a plurality of moving image frames Ft, and the encoded information.

The frame rate of the moving image frames obtained by the moving image decoding unit 110 is set at 15 Hz. The moving image data are output to the frame interpolating unit 140 and the display driver 150 while the encoded information is output to the aperiodic IDR detecting unit 120. The encoded information includes not only IDR, but also quantization parameter QP, motion vector MV, predictive mode information (intra-prediction/inter-prediction), block division and the like. For example, QP is utilized as the information for the scene change detection since it can be easily varied at the scene change. MV may be utilized as the information for discrimination of necessity for the frame interpolation from the degree of irregularity.

The aperiodic IDR detecting unit 120 refers to encoded information and measures an interval in which IDR (Instantaneous Decoder Refresh) is set periodically. An IDR frame is set to be generated within 2 seconds under the one-segment broadcasting standards, but the IDR frame often is not used further than required since the encoding efficiency is not so high. In other words, if the measured period interval is equal to or shorter than 2 seconds, there is strong possibility that the IDR frame is not a periodical frame, but a frame in a case where scene change occurs in a replayed image (hereinafter called an aperiodic IDR frame). For this reason, if the measured period interval is shorter than 2 seconds, the aperiodic IDR detecting unit 120 considers the IDR frame as the aperiodic IDR frame and varies an aperiodic IDR determination flag to 1. In addition, a buffer can be provided in the aperiodic IDR detecting unit 120 to store the aperiodic IDR determination flag. If a plurality of buffers are prepared, previous aperiodic IDR determination flags can be maintained therein. In this case, a determination result of a frame currently input at the 0-th time in the sequence is stored in advance, and determination results of frames previously input at the 1^{st} time or the subsequent times are stored in order of the time sequence. In other words, sort is performed every time a new determination result is generated. The aperiodic IDR determination flag buffer is delivered as control information of the frame interpolation control unit 130.

On the other hand, as for an image which does not have a law of two-second interval such as the one-segment broadcasting, for example, Internet distribution, scene change detection is performed in every frame since a two-second period law cannot be applied. A method of determination based on the inter-frame difference (Fₜ−Fₜ₋₁) is generally employed as a simple scene change detection method.

The frame interpolation control unit 130 controls the frame interpolation performed by the frame interpolating unit 140, in accordance with the notice from the aperiodic IDR detecting unit 120. In other words, the frame interpolation control unit 130 urges three interpolation processes (copy frame generation process, simple frame generation process and high-image-quality frame generation process) to be performed selectively by the frame interpolating unit 140, in accordance with the notice from the aperiodic IDR detecting unit 120.

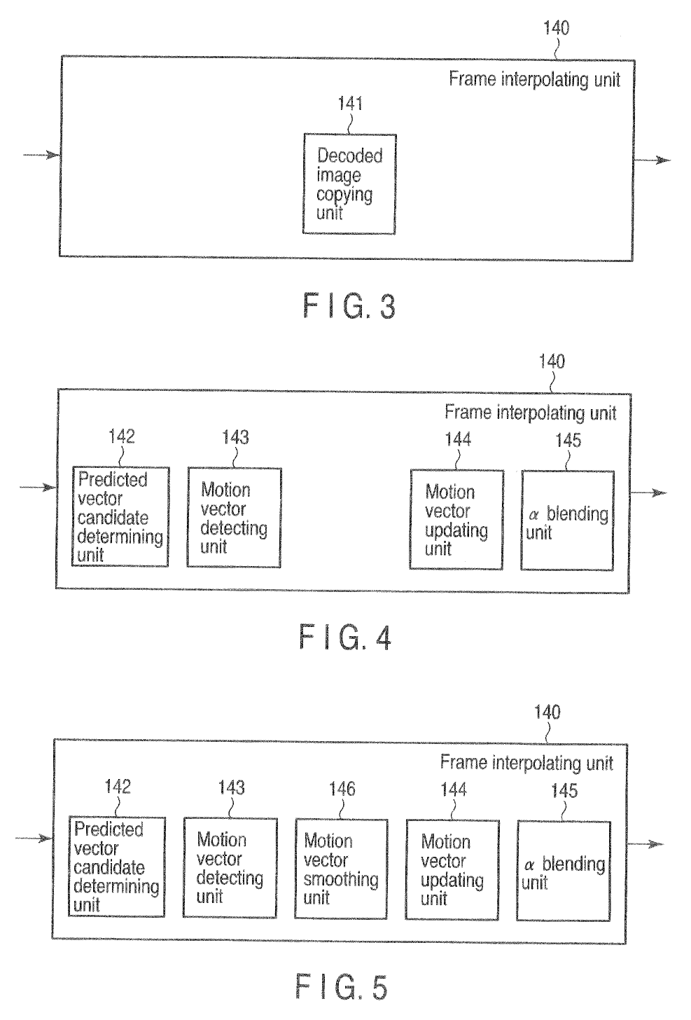

The frame interpolating unit 140 comprises a decoded image copying unit 141, a predicted vector candidate determining unit 142, a motion vector detecting unit 143, a motion vector updating unit 144, an α blending unit 145, and a motion vector smoothing unit 146, and generates an interpolation frame under an instruction from the frame interpolation control unit 130. If the copy frame generation process is performed, the decoded image copying unit 141 operates as shown in FIG. 3. If the simple frame generation process is performed, the predicted vector candidate determining unit 142, the motion vector detecting unit 143, the motion vector updating unit 144 and the a blending unit 145 operate as shown in FIG. 4. If the high-image-quality frame generation process is performed, the predicted vector candidate determining unit 142, the motion vector detecting unit 143, the motion vector smoothing unit 146, the motion vector updating unit 144, and the α blending unit 145 operate as shown in FIG. 5.

A function of each of the units constituting the frame interpolating unit 140 is described below.

The decoded image copying unit 141 duplicates the moving image frame decoded by the moving image decoding unit 110 and outputs the duplicated moving image frame as an interpolation frame.

The predicted vector candidate determining unit 142 obtains a plurality of predicted vector candidates for each of rectangular blocks constituting the interpolation frame. As for the predicted vector candidates, (1) motion vectors of a block which is adjacent to the rectangular block in the interpolation frame and which has the motion vector detection already ended, (2) motion vectors of a block which is spatially located at the same position as or adjacent to the rectangular block in the previous interpolation frame, (3) motion vectors of a block which is spatially located at the same position as or adjacent to the rectangular block in the decoded frame, and the like are used. All of the motion vectors do not need to be used, but it is important to select as the predicted vector candidates the motion vectors of blocks in point symmetry about the rectangular block. The motion vector detecting unit 143 calculates block errors (Fₜ(x−pmvx, y−pmvy)−Fₜ₋₁(x+pmvx, y+pmvy), x,y: coordinates of the block, pmvx,pmvy: predicted vector) indicated in the decoded moving image frame, at both ends in a time sequence, upon assigning to the rectangular block the predicted vector candidates obtained by the predicted vector candidate determining unit 142, for each rectangular block, and determines the predicted vector in which the calculated errors are minimum as the motion vector of the rectangular block. These processes are performed in the order of raster scanning of each of the rectangular blocks constituting the interpolation frame.

The motion vector smoothing unit 146 performs the smoothing process for the motion vector determined by the motion vector detecting unit 143, for each rectangular block, and moves an impulse noise-like motion vector from the block. The smoothing process of the motion vector outputs, for example, an intermediate value of nine items of the motion vector information in the block and the adjacent blocks. At this time, the intermediate value may be a one-dimensional vector or two-dimensional vector.

The motion vector updating unit 144 refers to the motion vector of the adjacent block, for the motion vector obtained by the predicted vector candidate determining unit 142 or the motion vector smoothed by the motion vector smoothing unit 146, and performs correction (fine adjustment) to minimize an alienation from the motion vector of the adjacent block. More specifically, the motion vector updating unit 144 moves the already determined motion vector from side to side and up and down within a range of one pixel, and corrects the already determined motion vector to a motion vector having the predicted error minimized in the range.

The a blending unit 145 calculates reliability of the motion vector determined by the motion vector updating unit 144 or the motion vector smoothing unit 146, from the statistic amount and distortion of the image and the continuity of the motion vector, on the basis of the motion vector corrected by the motion vector updating unit 144. On the basis of the reliability, the α blending unit 145 generates compensation blocks constituting the interpolation frame. Then, the α blending unit 145 synthesizes the compensation blocks corresponding to each other and generates the interpolation frame. The blocks are synthesized at a synthesis ratio based on the reliability.

The reliability is determined on the basis of motionSAD and zeroSAD calculated in the following equations.

$${F}_{t - 0.5} ( x , y ) = \frac{{F}_{t - 1} ( x , y ) + {F}_{t + 1} ( x , y )}{2} \cdot motionSAD + {F}_{t - 1} ( x , y ) \cdot zeroSAD / motionSAD + zeroSAD$$

$$motionSAD = {\sum }_{y = j}^{j + 15} {\sum }_{x = i}^{i + 15} \{ {F}_{t - 1} ( {x}_{i} - {mv}_{x} , {y}_{j} - {mv}_{y} ) - {F}_{t + 1} ( {x}_{i} + {mv}_{x} , {y}_{j} + {mv}_{y} ) \}$$

$$zeroSAD = {\sum }_{y = j}^{j + blocksize - 1} {\sum }_{x = i}^{i + blocksize - 1} \{ {F}_{t - 1} ( {x}_{i} - 0 , {y}_{j} - 0 ) - {F}_{t + 1} ( {x}_{i} + 0 , {y}_{j} + 0 ) \}$$

i, j: coordinates at the upper left block upon dividing F_{t-0.5}(x, y) into rectangular blocks

In other words, if the motion vector obtained by the motion vector updating unit 144 is correct, it is indicated that motionSAD follows an object, and motionSAD therefore becomes small. On the other hand, if motionSAD is greater than zeroSAD, it can be understood that the accuracy of the obtained motion vector is not desirable. Thus, the α blending is performed with motionSAD and zeroSAD serving as the reliability.

When interpolation frame F_{t-0.5} which interpolates an interval between asynchronous IDR frame Fₜ and frame Fₜ₋₁ followed by the asynchronous IDR frame is generated, the frame interpolation control unit 130 urges the frame interpolating unit 140 to perform the copy frame generation process (FIG. 3). The decoded image copying unit 141 thereby duplicates the frame followed by the asynchronous IDR frame and the frame interpolating unit 140 outputs the duplicated frame as interpolation frame F_{t-0.5}. The asynchronous IDR frame may be duplicated and the interpolation may be performed with the duplicated asynchronous IDR frame.

When the asynchronous IDR frame is detected, the frame interpolation control unit 130 urges the frame interpolating unit 140 to perform the simple frame generation process (FIG. 4) and generate an interpolation frame of a low image quality by the simplified process, during a predetermined period (some seconds, i.e. some tens of frames) after the detection. This process is based on the fact that it takes some time to recognize a new motion with a human eye after the scene change (after the detection of the asynchronous frame). The interpolation frame is generated by the simplified process in which the processing amount is small.

When the asynchronous IDR frame is not detected, the frame interpolation control unit 130 urges the frame interpolating unit 140 to perform the high image quality frame generation process (FIG. 5) and generate a high-image-quality interpolation frame. This process is based on the fact that when the moving image including no scene change is reproduced a human eye is sensitive to superiority and inferiority of the image quality. The interpolation is generated by the process in which the processing amount is large.

In other words, the motion vector smoothing unit 146 is not operated in the simple frame generation process while, in the high-image-quality frame generation process, the high-image-quality interpolation frame is generated by operating the motion vector smoothing unit 146.

The display driver 150 stores the moving image frame Ft supplied from the moving image decoding unit 110 and the interpolation frame F_{t-0.5} supplied from the frame interpolating unit 140, in the buffer memory, and outputs these frames alternately to the display unit 20. Each of the moving image frame Ft and the interpolation frame F_{t-0.5} has a frame rate of 15 Hz. By outputting these frames alternately by the display driver 150, the moving image data having a frame rate of 30 Hz can be output. Then, the display unit 20 displays the moving image data having a frame rate of 30 Hz .

In the image processing apparatus having the above-described configuration, necessity of the frame interpolation is determined on the basis of the encoding information obtained by decoding the encoded data of the moving image, and the interpolation frame of high image quality (large processing load) is generated in accordance with the degree of the necessity. More specifically, when the scene change occurs, it is noticed that the superiority and inferiority of the image quality can hardly be recognized by a human eye or the high-image-quality interpolation frame cannot be generated. In a case where the frame including the scene change (aperiodic IDR frame) is detected (a case where the necessity of the frame interpolation is small), she interpolation frame is generated before and after the frame by the simplified process. In the other case (a case where the necessity of the frame interpolation is great), the high-image-quality interpolation frame is generated.

Therefore, when the scene change occurs, power consumption can be lowered by reducing the load on the control unit 100 and the frame interpolation which can be sufficiently recognized as high image quality by a human sensing ability can be performed.

In addition, when the interpolation is performed before and after the scene change, the frame followed by the asynchronous IDR frame is duplicated to generate the interpolation frame. Therefore, the processing load can be reduced as compared with a case of synthesizing the interpolation frame.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different, embodiments may be combined arbitrarily.

In the above-described embodiment, for example, when the interpolation is performed before and after then scene change, the frame followed by the asynchronous IDR frame is duplicated and the interpolation is performed with the duplicated frame. Instead of this, however, the asynchronous IDR frame may be duplicated and the interpolation may be performed with the duplicated frame.

In addition, in the above-described embodiment, the necessity of the frame interpolation is determined in accordance with the occurrence of the scene change. However, the necessity of the frame interpolation may be determined in accordance with the other information included in the encoding information.

The present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a receiving unit which receives data including a plurality of encoded moving image frames and encoding information referred to upon decoding each of the encoded moving image frames;
a decoder which decodes the data received by the receiving unit and extracts the plurality of moving image frames and the encoding information;
an interpolation frame generating unit which generates an interpolation frame to be inserted into the plurality of timely sequential moving image frames extracted by the decoder; and
a detector which detects a specific moving image frame in accordance with the encoding information extracted by the decoder,
wherein if the detector detects the specific moving image frame, the interpolation frame generating unit generates the interpolation frame inserted between the detected specific moving image frame and a moving image frame followed by the specific moving image frame by duplicating the detected specific moving image frame or the moving image frame followed by the specific moving image frame, and if the detector does not detect the specific moving image frame, the interpolation frame generating unit generates the interpolation frame inserted between a moving image frame which is not detected as the specific moving image frame and a moving image frame followed by the moving image frame in accordance with a motion vector obtained each of blocks constituting the interpolation frame.

2. The apparatus according to claim 1, wherein if an aperiodic IDR frame is detected, the detector determines the detected frame as the specific moving image frame.

3. The apparatus according to claim 1, wherein the detector measures an interval of the IDR frame and, if the measured interval is equal to or shorter than a predetermined time, the detector determines the IDR frame as the specific moving image frame.

4. The apparatus according to claim 1, wherein if the specific moving image frame is not detected by the detector, the interpolation frame generating unit obtains the motion vector in accordance with a motion vector already obtained for a block which adjacent to the block for obtaining a motion vector in the interpolation frame and which has a motion vector obtained.

5. The apparatus according to claim 1, wherein if the specific moving image frame is not detected by the detector, the interpolation frame generating unit determines the motion vector of the block constituting the interpolation frame as a motion vector of a block which constitutes the decoded moving image frame present before or after the interpolation frame and which is located at the same position as the block constituting the interpolation frame having the motion vector obtained.

6. An image processing apparatus comprising:
a receiving unit which receives data including a plurality of encoded moving image frames and encoding information referred to upon decoding each of the encoded moving image frames;
a decoder which decodes the data received by the receiving unit and extracts the plurality of moving image frames and the encoding information;
an interpolation frame generating unit which generates an interpolation frame to be inserted into the plurality of timely sequential moving image frames extracted by the decoder; and
a detector which detects that a scene has been changed in accordance with the encoding information extracted by the decoder,
wherein if the detector detects that the scene has been changed, the interpolation frame generating unit generates the interpolation frame inserted between a moving image frame of the changed scene and a moving image frame followed by the moving image frame of the changed scene by duplicating the moving image frame or the moving image frame followed by the moving image frame of the changed scene, and if the detector does net detect that the scene has been changed, the interpolation frame generating unit generates the interpolation frame inserted between a moving image frame which is not detected that the scene has been changed and a moving image frame followed by the moving image frame in accordance with a motion vector obtained each of blocks constituting the interpolation frame.

7. The apparatus according to claim 6, wherein if an aperiodic IDR frame is detected, the detector determines that the scene has been changed.

8. The apparatus according to claim 6, wherein the detector measures an interval of the IDR frame and, if the measured interval is equal to or shorter than a predetermined time, the detector determines the scene has been changed.

9. The apparatus according to claim 6, wherein if it is not detected by the detector that the scene has been changed, the interpolation frame generating unit obtains the motion vector in accordance with a motion vector already obtained for a block adjacent to a block which adjacent to the block for obtaining a motion vector constitutes in the interpolation frame and which has a motion vector obtained.

10. The apparatus according to claim 6, wherein if it is not detected by the detector that the scene has been changed, the interpolation frame generating unit determines the motion vector of the block constituting the interpolation frame as a motion vector of a block which constitutes the decoded moving image frame present before or after the interpolation frame and which is located at the same position as the block constituting the interpolation frame having the motion vector obtained.

11. An image processing method comprising:
receiving data including a plurality of encoded moving image frames and encoding information referred to upon decoding each of the encoded moving image frames;
decoding the data received by the receiving and extracting the plurality of moving image frames and the encoding information;
generating an interpolation frame to be inserted into the plurality of timely sequential moving image frames extracted by the decoding; and
detecting a specific moving image frame in accordance with the encoding information extracted by the decoding,
wherein if the specific moving image frame is detected by the detecting, the interpolation frame inserted between the detected specific moving image frame and a moving image frame followed by the specific moving image frame is generated by duplicating the detected specific moving image frame or the moving image frame followed by the specific moving image frame, and if the specific moving image frame is not detected, the interpolation frame inserted between a moving image frame which is not detected as the specific moving image frame and a moving image frame followed by the moving image frame is generated in accordance with a motion vector obtained each of blocks constituting the interpolation frame.

12. The method according to claim 11, wherein if an aperiodic IDR frame is detected, the detecting determines the detected frame as the specific moving image frame.

13. The method according to claim 11, wherein the detector measures an interval of the IDR frame and, if
the measured interval is equal to or shorter than a predetermined time, the detector determines the IDR frame as the specific moving image frame.

14. The method according to claim 11, wherein if the specific moving image frame is not detected by the detecting, the interpolation frame generation obtains the motion vector in accordance with a motion vector already obtained for a block which adjacent to the block for obtaining a motion vector in the interpolation frame and which has a motion vector obtained.

15. The method according to claim 11, wherein if the specific moving image frame is not detected by the detector, the interpolation frame generation determines the motion vector of the block constituting the interpolation frame as a motion vector of a block which constitutes the decoded moving image frame present before or after the interpolation frame and which is located at the same position as the block constituting the interpolation frame having the motion vector obtained.

16. An image processing method comprising:
receiving data including a plurality of encoded moving image frames and encoding information referred to upon decoding each of the encoded moving image frames;
decoding the data received by the receiving and extracts the plurality of moving image frames and the encoding information;
generating an interpolation frame to be inserted into the plurality of timely sequential moving image frames extracted by the decoding; and
detecting that a scene has been changed in accordance with the encoding information extracted by the decoding,
wherein if it is detected by the detecting that the scene has been changed, the interpolation frame inserted between a moving image frame of the changed scene and a moving image frame followed by the moving image frame of the changed scene by duplicating the moving image frame or the moving image frame followed by the moving image frame of the changed scene, and if it is not detected that the scene has been changed, the interpolation frame inserted between a moving image frame of the scene whose change is not detected and a moving image frame followed by the moving image frame in accordance with a motion vector obtained each of blocks constituting the interpolation frame.

17. The method according to claim 16, wherein if an aperiodic IDR frame is detected, the detecting determines that the scene has been changed.

18. The apparatus according to claim 16, wherein the detector measures an interval of the IDR frame and, if the measured interval is equal to or shorter than a predetermined time, the detector determines the scene has been changed.

19. The method according to claim 16, wherein if it is not detected by the detecting that the scene has been changed, the interpolation frame generation obtains the motion vector in accordance with a motion vector already obtained for a block adjacent to a block which adjacent to the block for obtaining a motion vector constitutes in the interpolation frame and which has a motion vector obtained.

20. The method according to claim 16, wherein if it is not detected by the detecting that the scene has been changed, the interpolation frame generation determines the motion vector of the block constituting the interpolation frame as a motion vector of a block which constitutes the decoded moving image frame present before or after the interpolation frame and which is located at the same position as the block constituting the interpolation frame having the motion vector obtained.
